(19) United States
(12) Patent Application Publication
(10) Pub. No.: US 2018/0043326 A1
(43) Pub. Date: Feb. 15, 2018

(54) ULTRA LOW PRESSURE CONTINUOUS CATALYST TRANSFER WITH LOCK HOPPER

(71) Applicant: UOP LLC, Des Plaines, IL (US)

(72) Inventors: Charles Brabson, Humble, TX (US); Rajeswar Gattupalli, Buffalo Grove, IL (US); Richard Gaicki, Chicago, IL (US); Kyle P. Austin, Algonquin, IL (US); Christopher Naunheimer, Arlington Heights, IL (US); Michael J. Vetter, Schaumburg, IL (US)

(21) Appl. No.: 15/798,322

(22) Filed: Oct. 30, 2017

Related U.S. Application Data
(63) Continuation of application No. PCT/US2016/036797, filed on Jun. 10, 2016.
(60) Provisional application No. 62/183,922, filed on Jun. 24, 2015.

(51) Int. Cl. B01J 8/00

(52) U.S. Cl. CPC B01J 8/0025; B01J 2208/00761

(57) ABSTRACT

An apparatus is presented for the transferring of catalyst from an upstream vessel to a downstream vessel. The apparatus includes a non-mechanical valve and a transfer line, wherein a lift gas provides for carrying catalyst through the transfer line. The non-mechanical valve has a catalyst inlet and a lift gas inlet to provide for a consistent flow of catalyst and lift gas to the transfer line.

### CROSS-REFERENCE TO RELATED APPLICATIONS

This application is a Continuation of copending International Application No. PCT/US2016/036797 filed Jun. 10, 2016 which application claims benefit of U.S. Provisional Application No. 62/183,922 filed Jun. 24, 2015, now expired, the contents of which cited applications are hereby incorporated by reference in their entirety.

### FIELD OF THE INVENTION

The present invention relates to solids transfer equipment. In particular, the invention is directed to the low pressure transfer of catalyst particles between reactors, or a reactor and a regenerator.

### BACKGROUND

Many modern chemical processes utilize catalysts for the conversion of a feedstock to a more valuable product stream. Catalysts have a limited life of operation before a need for the regeneration of the catalyst. In many chemical operations, the process involves passing a catalyst between a reactor to a regenerator and back again to provide for a long continuous operation.

However, a continuous catalyst regeneration technology in use today does not provide for a continuous constant rate of catalyst circulation. The process today involves the use of lock hoppers and lift engagers to circulate catalyst in small batches to provide for a semi-continuous process. This batch-wise catalyst transfer process can lead to catalyst bridging and the plugging of catalyst transfer lines.

There is a need to improve the process and equipment for the transfer of catalyst in a continuous catalyst regeneration system.

### SUMMARY

The present invention is an improvement for the low pressure transfer of solids in chemical reactor equipment.

A first embodiment of the invention is an apparatus for the transfer of catalyst comprising a vessel from a terminal reactor having an inlet and an outlet; a non-mechanical valve having a catalyst inlet in fluid communication with the vessel outlet, at least one lift gas inlet, and an outlet; a transfer line having an inlet in fluid communication with the non-mechanical valve outlet, and an outlet; a first downstream vessel having an inlet in fluid communication with the transfer line, and a gas outlet and a catalyst outlet; a second downstream vessel having an inlet in fluid communication with the first downstream vessel outlet; and an outlet; and a third downstream vessel having an inlet in fluid communication with the second downstream vessel outlet, and an outlet. An embodiment of the invention is one, any or all of prior embodiments in this paragraph up through the first embodiment in this paragraph further comprising an impactless elbow disposed in the transfer line and at a position in the transfer line at an elevated position relative to the first downstream vessel. An embodiment of the invention is one, any or all of prior embodiments in this paragraph up through the first embodiment in this paragraph wherein the transfer line further includes a second inlet for admitting a second lift gas. An embodiment of the invention is one, any or all of prior embodiments in this paragraph up through the first embodiment in this paragraph wherein the second inlet is in a position in the transfer line disposed below the inlet from the non-mechanical valve outlet. An embodiment of the invention is one, any or all of prior embodiments in this paragraph up through the first embodiment in this paragraph further comprising; a second non-mechanical valve having an inlet in fluid communication with the third downstream vessel outlet, a lift gas inlet and an outlet. An embodiment of the invention is one, any or all of prior embodiments in this paragraph up through the first embodiment in this paragraph further comprising a second transfer line having an inlet in fluid communication with the second non-mechanical valve outlet, and an outlet. An embodiment of the invention is one, any or all of prior embodiments in this paragraph up through the first embodiment in this paragraph further comprising a second impactless elbow disposed in the second transfer line and at a position in the transfer line at an elevated position relative to a fourth downstream vessel. An embodiment of the invention is one, any or all of prior embodiments in this paragraph up through the first embodiment in this paragraph wherein the second transfer line further includes a second inlet for admitting a second lift gas. An embodiment of the invention is one, any or all of prior embodiments in this paragraph up through the first embodiment in this paragraph wherein the second inlet is in a position in the second transfer line disposed below the inlet from the second non-mechanical valve outlet. An embodiment of the invention is one, any or all of prior embodiments in this paragraph up through the first embodiment in this paragraph wherein the non-mechanical valve comprises a horizontal length of pipe having a first inlet for admitting catalyst particles, a second inlet for admitting a lift gas, and an outlet.

A second embodiment of the invention is an apparatus for the transfer of catalyst from a reactor to a regenerator, comprising a first vessel from a terminal reactor having an inlet and an outlet; a first non-mechanical valve having a catalyst inlet in fluid communication with the first vessel outlet, a lift gas inlet, and an outlet; a first transfer line having an inlet in fluid communication with the first non-mechanical valve outlet, and an outlet; a first downstream vessel having an inlet in fluid communication with the first transfer line, and a gas outlet and a catalyst outlet; a second downstream vessel having an inlet in fluid communication with the first downstream vessel outlet; and an outlet; a third downstream vessel having an inlet in fluid communication with the second downstream vessel outlet, and an outlet; a second non-mechanical valve having an inlet in fluid communication with the third downstream vessel outlet, a lift gas inlet and an outlet; and a second transfer line having an inlet in fluid communication with the second non-mechanical valve outlet and an outlet in fluid communication with a downstream vessel regenerator. An embodiment of the invention is one, any or all of prior embodiments in this paragraph up through the second embodiment in this paragraph wherein the first transfer line further includes a second inlet for admitting a second lift gas. An embodiment of the invention is one, any or all of prior embodiments in this paragraph up through the second embodiment in this paragraph wherein the second inlet is in a position in the first transfer line disposed below the inlet from the first non-mechanical valve outlet. An embodiment of the invention is one, any or all of prior embodiments in this paragraph up through the second embodiment in this paragraph wherein the non-mechanical valve comprises a horizontal length of pipe having a first inlet for admitting catalyst particles, a second inlet for admitting a lift gas, and an outlet. An embodiment of the invention is one, any or all of prior embodiments in this paragraph up through the second embodiment in this paragraph wherein the second transfer line further includes a second inlet for admitting a second lift gas. An embodiment of the invention is one, any or all of prior embodiments in this paragraph up through the second embodiment in this paragraph wherein the second inlet is in a position in the second transfer line disposed below the inlet from the second non-mechanical valve outlet.

A third embodiment of the invention is a process for transferring catalyst from a reactor to another reactor, comprising passing catalyst from a first vessel to a non-mechanical valve; passing a lift gas to the non-mechanical valve to carry the catalyst to a transfer line; passing a lift gas to the transfer line to lift the catalyst up the transfer line; and passing the lifted catalyst to a first downstream vessel; wherein the pressure at the inlet to the non-mechanical valve is at least 10 kPa (gauge). An embodiment of the invention is one, any or all of prior embodiments in this paragraph up through the third embodiment in this paragraph wherein the pressure at the inlet to the non-mechanical valve is at least 7 kPa (gauge). An embodiment of the invention is one, any or all of prior embodiments in this paragraph up through the third embodiment in this paragraph wherein the pressure at the inlet to the non-mechanical valve is at least 4 kPa (gauge). An embodiment of the invention is one, any or all of prior embodiments in this paragraph up through the third embodiment in this paragraph wherein the lift gas comprises hydrogen

Other objects, advantages and applications of the present invention will become apparent to those skilled in the art from the following detailed description and drawings.

### BRIEF DESCRIPTION OF THE DRAWINGS

FIG. 1 is the apparatus for transferring catalyst from a terminal reactor to a catalyst regenerator; and

FIG. 2 is the apparatus for transferring catalyst between an upstream reactor and a downstream reactor.

### DETAILED DESCRIPTION

In a current olefin conversion process, a continuous catalyst regeneration (CCR) technology is used the utilizes a batch-wise transfer system, wherein small amounts of catalyst are collected and then transferred. This utilizes equipment, such as lock hoppers and lift engagers and complex valving for the transfer of catalyst from a reactor to a regenerator. The transfer of catalyst through this equipment is subject to catalyst plugging of transfer lines and valves, and the attrition of the catalyst as the catalyst is eroded in the transfer process.

The present invention allows for a reduced catalyst plugging and reduced catalyst attrition. The apparatus also provides for a continuous flow to a catalyst regenerator for a more consistent operation of the regenerator. In particular, in the current Oleflex™ technology, catalyst flows from the annular space between the Oleflex reactor screens through a series of catalyst transfer pipes into an external catalyst collector. From the catalyst collector, the catalyst then flows into a lift engager, where the catalyst batch is lifted into the top of the next reactor. In the final Oleflex reactor, a lock hopper is located between the catalyst collector and a lift engager; the lock hopper is used to change catalyst atmospheres from hydrogen/hydrocarbon environment to a nitrogen environment so that the catalyst can be safely regenerated. Similarly, in the catalyst lift from the CCR regenerator to the first Oleflex reactor, a lock hopper is used upstream of the lift engager to change from a nitrogen atmosphere to a hydrogen atmosphere before the catalyst enters the first reactor.

The batch lifting of catalyst through the system necessitates the use of higher catalyst velocities that would be required for constant-rate catalyst circulation. In addition, the complex valving required for the lock hoppers and lift engagers coupled with the higher catalyst velocity result in increased catalyst attrition rates.

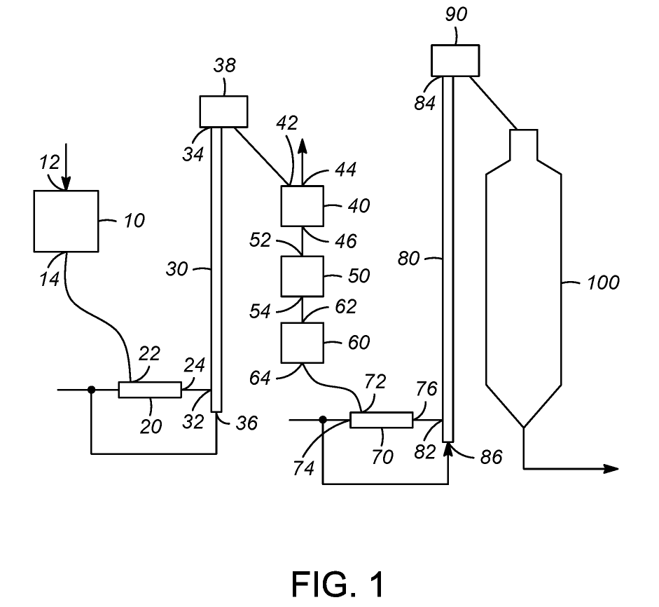

The present invention is an apparatus for the transfer of catalyst. The transfer is from a reactor to a regenerator. As shown in FIG. 1, the apparatus includes a vessel 10 from a terminal reactor, wherein the vessel 10 has a catalyst inlet 12 and a catalyst outlet 14. The vessel 10 can also be a part of the terminal reactor where catalyst is collected as it leaves the reactor catalyst bed. This would be typically from a moving bed reactor wherein the catalyst flows down an annular reactor bed. The apparatus further includes a non-mechanical valve 20 having a catalyst inlet 22 in fluid communication with the catalyst outlet 14 from the vessel 10, and a catalyst outlet 24. A transfer line 30 has an inlet 32 that connects to the non-mechanical valve catalyst outlet 24, and a transfer line outlet 34. The apparatus further includes a first downstream vessel 40 having an inlet 42 in fluid communication with the transfer line outlet 34, and the first downstream vessel 40 has a gas outlet 44 and a catalyst outlet 46. The apparatus further includes a second downstream vessel 50 having an inlet 52 in fluid communication with the first downstream vessel outlet 46, and an outlet 54, and a third downstream vessel 60 having an inlet in fluid communication with the second downstream vessel outlet 54 and an outlet 64.

In order to minimize catalyst erosion, or attrition, the apparatus can include an impactless elbow 38 attached to the transfer line outlet 34. The transfer line 30 is oriented to elevate catalyst from the non-mechanical valve 20 to the first downstream vessel 40, and is oriented such that the outlet 34 has an elevation greater than the inlet 32. Typically, the transfer line will have a vertical orientation. The transfer line 30 can further include a second inlet 36 for admitting a second lift gas stream. The position of the second inlet 36 in the transfer line 30 is below the inlet 32 from the non-mechanical valve outlet 24 for providing additional lifting gas to carry the catalyst particles to the outlet 34 of the transfer line 30.

The apparatus can further include a second part for a further transfer of catalyst to the regenerator 100. The second part includes a second non-mechanical valve 70 having an inlet 72 in fluid communication with the third downstream vessel outlet 64, a lift gas inlet 74 to the valve and an outlet 76. The second part further includes a second transfer line 80 having an inlet 82 in fluid communication with the second valve outlet 76, and a second transfer line outlet 84. The second transfer line 80 can further include a second inlet 86 for admitting a second lift gas stream.

A second impactless elbow 90 has an inlet in fluid communication with the second transfer line outlet 84 and the second transfer line 80 is oriented with a vertical orientation where the outlet 84 is elevated above the inlet 82. The second impactless elbow 90 has an outlet 92 and is disposed in a position elevated above a fourth downstream vessel 100. In this particular embodiment, the fourth downstream vessel is the regenerator.

An impactless elbow is a device for receiving a flowing fluid carrying solid particles, and has an expanded diameter to allow the fluid to slow and have the particles slow down or even settle out without having to impact the walls of the device. An impactless elbow can be a pipe with an enlarged diameter and curved to redirect the flow without having the catalyst particles impinging on the walls of the elbow. This reduces attrition of the catalyst.

The non-mechanical valve 20, 70 is a system for transferring a flowing solid with a fluid. The valve comprises a horizontal length of conduit, or piping, having an inlet for the solid particles to be carried in, and a second inlet for a fluid to carry the particles. The fluid can be a lifting gas. The conduit includes an outlet for the flowing fluid with the particles. The outlet to the non-mechanical valve carries the flowing fluid with the particles to a transfer line 30, 80, wherein the particles are transferred to an elevated position and allowed to flow by gravity to a receiving vessel.

The particles are allowed to flow in a continuous manner to with a continuous flowing lift gas to provide a smoother, more consistent and continuous transfer of particles between vessels without moving parts.

In one embodiment, the first downstream vessel 40 comprises a disengaging drum where the lift gas and catalyst particles are separated. The disengaging drum allows the particles to settle out from the lift gas by slowing the flow sufficiently that the particles are no longer able to be carried by the lift gas. The disengaging drum has an outlet for the gas without the particles and a second outlet for the particles. In this embodiment, the second downstream vessel 50 is a lock-hopper for transferring the particles through a gravity driven mode to a higher pressure. A lock-hopper is a vessel with an entrance valve to form a pressure tight seal and an exit valve to form a pressure type seal. The entrance valve and exit valve are open and closed alternately such that both are not in an “open” state at the same time. This allows the transfer from one vessel above the lock-hopper to another vessel below the lock-hopper. The lock-hopper can include the ability to pressurize the lock-hopper to allow for transfer from a lower pressure vessel to a higher pressure vessel. In this embodiment, the third downstream vessel is a surge drum to allow collection of batches of catalyst and provide for a continuous flow of catalyst to the second non-mechanical valve.

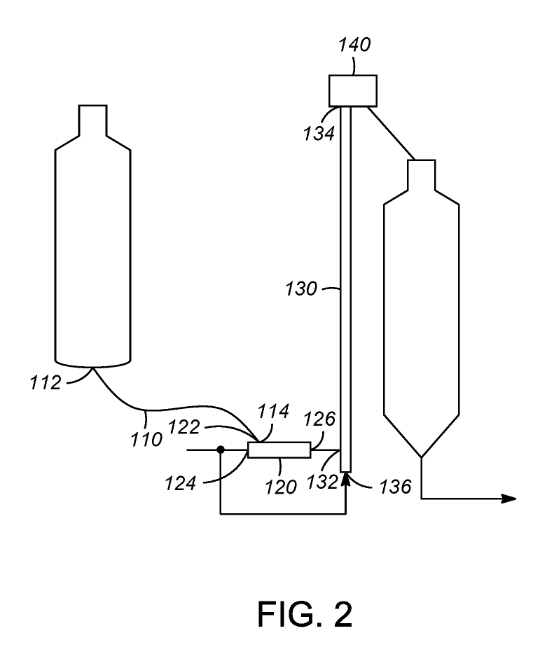

In another embodiment as shown in FIG. 2, the apparatus can be a catalyst transfer system for transferring catalyst between reactors in series. The apparatus for transfer of catalyst comprises a first catalyst feeder conduit 110 having an inlet 112 for receiving catalyst from an upstream reactor, and an outlet 114. The apparatus further includes a non-mechanical valve 120 having an inlet 122 in fluid communication with the first catalysts feeder conduit outlet 114, a lift gas inlet 124, and an outlet 126. The apparatus further includes a transfer line 130 having an inlet 132 that is in fluid communication with the non-mechanical valve outlet 126 and a transfer line outlet 134. The transfer line 130 can further include a second lift gas inlet 136 disposed below the inlet 132 in fluid communication with the non-mechanical valve outlet. The transfer line has a substantially vertical orientation with the transfer line outlet 134 at a higher elevation than the transfer line inlet 132. The apparatus can include an impactless elbow 140 in fluid communication with the transfer line outlet 134. The lift gas in a hydrocarbon processing unit can be hydrogen.

The apparatus can include a vessel for receiving catalyst from the upstream reactor, or the catalyst can collect in the bottom of the upstream reactor to be transferred by gravity to the first transfer conduit.

The non-mechanical valve and transfer line allow consistent and continuous transfer of catalyst from an upstream reactor to a downstream reactor, and for a lower pressure drop during the transfer. This provides one with the capability to transfer catalyst in a low pressure system without having to add a compressed gas for transferring the catalyst. The apparatus allows for transferring catalyst with as low as a 3.5 kPa-gauge pressure drop.

Another embodiment of the present invention is a process for transferring catalyst from an upstream reactor to a downstream reactor. The process includes passing catalyst from the upstream reactor to a non-mechanical valve, and passing a lift gas to the non-mechanical valve to generate a flow stream comprising the lift gas and catalyst. The flow stream is passed to a transfer line to lift the catalyst up the transfer line to generate a lifted catalyst. The lifted catalyst is passed to the downstream reactor, or vessel, wherein the pressure used to transfer the catalyst is less than 10 kPa (gauge). The pressure drop for passing the catalyst can be as low as 7 kPa, and as low as 4 kPa.

While the invention has been described with what are presently considered the preferred embodiments, it is to be understood that the invention is not limited to the disclosed embodiments, but it is intended to cover various modifications and equivalent arrangements included within the scope of the appended claims.

What is claimed is:

1. An apparatus for the transfer of catalyst comprising:
a vessel from a terminal reactor having an inlet and an outlet;
a non-mechanical valve having a catalyst inlet in fluid communication with the vessel outlet, at least one lift gas inlet, and an outlet;
a transfer line having an inlet in fluid communication with the non-mechanical valve outlet, and an outlet;
a first downstream vessel having an inlet in fluid communication with the transfer line, and a gas outlet and a catalyst outlet;
a second downstream vessel having an inlet in fluid communication with the first downstream vessel outlet; and an outlet; and
a third downstream vessel having an inlet in fluid communication with the second downstream vessel outlet, and an outlet.

2. The apparatus of claim 1 further comprising an impactless elbow disposed in the transfer line and at a position in the transfer line at an elevated position relative to the first downstream vessel.

3. The apparatus of claim 1 wherein the transfer line further includes a second inlet for admitting a second lift gas.

4. The apparatus of claim 3 wherein the second inlet is in a position in the transfer line disposed below the inlet from the non-mechanical valve outlet.

5. The apparatus of claim 1 further comprising;
a second non-mechanical valve having an inlet in fluid communication with the third downstream vessel outlet, a lift gas inlet and an outlet.

6. The apparatus of claim 5 further comprising a second transfer line having an inlet in fluid communication with the second non-mechanical valve outlet, and an outlet.

7. The apparatus of claim 6 further comprising a second impactless elbow disposed in the second transfer line and at a position in the transfer line at an elevated position relative to a fourth downstream vessel.

8. The apparatus of claim 5 wherein the second transfer line further includes a second inlet for admitting a second lift gas.

9. The apparatus of claim 8 wherein the second inlet is in a position in the second transfer line disposed below the inlet from the second non-mechanical valve outlet.

10. The apparatus of claim 1 wherein the non-mechanical valve comprises:
a horizontal length of pipe having a first inlet for admitting catalyst particles, a second inlet for admitting a lift gas, and an outlet.

11. An apparatus for the transfer of catalyst from a reactor to a regenerator, comprising:
a first vessel from a terminal reactor having an inlet and an outlet;
a first non-mechanical valve having a catalyst inlet in fluid communication with the first vessel outlet, a lift gas inlet, and an outlet;
a first transfer line having an inlet in fluid communication with the first non-mechanical valve outlet, and an outlet;
a first downstream vessel having an inlet in fluid communication with the first transfer line, and a gas outlet and a catalyst outlet;
a second downstream vessel having an inlet in fluid communication with the first downstream vessel outlet; and an outlet;
a third downstream vessel having an inlet in fluid communication with the second downstream vessel outlet, and an outlet;
a second non-mechanical valve having an inlet in fluid communication with the third downstream vessel outlet, a lift gas inlet and an outlet; and
a second transfer line having an inlet in fluid communication with the second non-mechanical valve outlet and an outlet in fluid communication with a downstream vessel regenerator.

12. The apparatus of claim 11 wherein the first transfer line further includes a second inlet for admitting a second lift gas.

13. The apparatus of claim 12 wherein the second inlet is in a position in the first transfer line disposed below the inlet from the first non-mechanical valve outlet.

14. The apparatus of claim 11 wherein the non-mechanical valve comprises:
a horizontal length of pipe having a first inlet for admitting catalyst particles, a second inlet for admitting a lift gas, and an outlet.

15. The apparatus of claim 11 wherein the second transfer line further includes a second inlet for admitting a second lift gas.

16. The apparatus of claim 15 wherein the second inlet is in a position in the second transfer line disposed below the inlet from the second non-mechanical valve outlet.

17. A process for transferring catalyst from a reactor to another reactor, comprising:
passing catalyst from a first vessel to a non-mechanical valve;
passing a lift gas to the non-mechanical valve to carry the catalyst to a transfer line;
passing a lift gas to the transfer line to lift the catalyst up the transfer line; and
passing the lifted catalyst to a first downstream vessel;
wherein the pressure at the inlet to the non-mechanical valve is at least 10 kPa (gauge).

18. The process of claim 17 wherein the pressure at the inlet to the non-mechanical valve is at least 7 kPa (gauge).

19. The process of claim 17 wherein the pressure at the inlet to the non-mechanical valve is at least 4 kPa (gauge).

20. The process of claim 17 wherein the lift gas comprises hydrogen.
